(19) United States
(12) Patent Application Publication
(10) Pub. No.: US 2018/0335531 A1
(43) Pub. Date: Nov. 22, 2018

(54) SALT PROXIMITY IMAGING USING REVERSE TIME MIGRATION OF TRANSMITTED VERTICAL SEISMIC PROFILE DATA

(71) Applicant: CGG SERVICES SAS, Massy Cedex (FR)

(72) Inventors: Andrew RATCLIFFE, Henfield (GB); Francesco PERRONE, Crawley (GB); Graham ROBERTS, Forest Row (GB); Martin CHAPPELL, Reigate (GB)

(21) Appl. No.: 15/970,967

(22) Filed: May 4, 2018

Related U.S. Application Data
(60) Provisional application No. 62/508,485, filed on May 19, 2017.

(51) Int. Cl. G01V 1/28; G01V 1/30

(52) U.S. Cl. CPC G01V 1/282; G01V 1/307; G01V 2210/161; G01V 2210/6222; G01V 2210/1295; G01V 2210/679; G01V 2210/1429

(57) ABSTRACT

A method for obtaining an image of an explored subsurface formation. The method includes receiving seismic data, wherein the seismic data is associated with a source or a seismic sensor placed in a well; forward propagating a first wavelet from the source using a first velocity model; backward propagating a second wavelet from the seismic sensor using a second velocity model, which is different from the first velocity model; and applying an imaging condition to the forward propagated first wavelet and the backward propagated second wavelet to calculate a reflectivity of the subsurface.

### CROSS REFERENCE TO RELATED APPLICATIONS

This application claims priority and benefit from U.S. Provisional Patent Application No. 62/508,485 filed on May 19, 2017, for “Salt proximity using reverse time imaging of transmitted vertical seismic profile arrivals,” the content of which is incorporated in its entirety herein by reference.

### BACKGROUND

### Technical Field

Embodiments of the subject matter disclosed herein generally relate to survey data processing, and more particularly, to obtaining an image of an explored subsurface structure that is shielded by a salt formation, by using transmitted vertical seismic profile data.

### Discussion of the Background

Seismic exploration of subsurface geophysical structures is customarily used to locate and monitor oil and gas reservoirs. Reflections of seismic waves traveling through the explored subsurface formation are detected by sensors (also known as “receivers”) that record seismic signal versus time values, known as seismic data. Seismic data is processed to identify locations of layer interfaces crossed by the detected waves and the nature of the explored formation's layers, yielding a profile (image) of the formation. This type of seismic exploration is used for formations under land areas and under water bottom surfaces.

FIG. 1 illustrates a land seismic survey system 100 that surveys an oil and gas reservoir 102. In top of the oil and gas reservoir 102 there is a salt dome 104. Salt domes are known to affect the propagation of sound waves. In this regard, note that one or more sources S (a truck 110 is shown in the figure as carrying the seismic source S) are moved at the surface 106 of the earth, about the subsurface 112 to be explored and sound waves 114 are generated at various shot points. The sound waves 114 propagate down into the subsurface 112 and they get reflected and/or refracted at various interfaces, where the Earth's properties change. FIG. 1 shows, for simplicity, that sound waves 114 get reflected only at the top of the oil and gas reservoir 102. Those skilled in the art would know that the sound waves get reflected at many other points in the subsurface. The various velocities experienced by the sound waves in the subsurface constitute the velocity model, which is usually constructed based on the travel time of the sound waves from the source S to a seismic receiver R.

The reflected sound wave 116 enters the salt dome 104, where it gets deviated from the normal propagation because the salt dome is not homogenous, and thus, there are many portions inside the salt dome having different physical characteristics, which make the sound waves to propagate with different velocities and suffer multiple reflections, refractions and diffractions.

Thus, when the reflected sound waves 116 arrive at the seismic receivers R, which in this figure are shown being distributed at the surface 106 of the earth, the information carried by them is negatively impacted by the salt dome, i.e., the velocity model is likely not describing well the path of the rays through the salt dome. Knowledge of salt dome boundary locations at the salt flanks and base is important for updating the velocity models, getting better sub-surface images, estimating reservoir size, and minimizing drilling risks for exploration and development wells in and near salt (Li and Hewlett, 2014). However, the ray tracing model illustrated in FIG. 1 for determining the path of the incident and reflected sound waves fails, or suffers from erratic behavior, in the presence of the salt dome.

Therefore, there is a need to better estimate the velocity model in a subsurface in which there is a salt dome so that a more accurate image of the oil and gas reservoirs may be obtained.

### SUMMARY

According to an embodiment, there is a method for obtaining an image of an explored subsurface formation. The method includes receiving seismic data, wherein the seismic data is associated with a source or a seismic sensor placed in a well; forward propagating a first wavelet from the source using a first velocity model; backward propagating a second wavelet from the seismic sensor using a second velocity model, which is different from the first velocity model; and applying an imaging condition to the forward propagated first wavelet and the backward propagated second wavelet to calculate a reflectivity of the subsurface.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a traditional land seismic data acquisition system;

FIG. 2 illustrates a well based seismic data acquisition system;

FIG. 3 is a flowchart of a method for generating an image of a subsurface that includes a salt;

FIG. 4 illustrates the application of the method of FIG. 3 to a simple model;

FIG. 5 is a flowchart of a method for processing seismic data; and

FIG. 6 is a schematic diagram of a data processing apparatus according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed in the context of processing seismic data. However, similar methods may be employed when other types of waves (e.g., electromagnetic waves) are used to explore an underground formation.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The traditional salt proximity process (also known as salt exit point analysis) is a borehole seismic refraction method. In this method, 3D ray tracing in two velocity models (salt flood and sediment models) is used to calculate the salt exit points by matching modelled ray directions and travel-times with P-wave first arrival travel-times and directions (azimuth and incidence angles) extracted from vertical seismic profile (VSP) data. In this way, the salt flank interface is mapped (see, for example, Li et al., 2003).

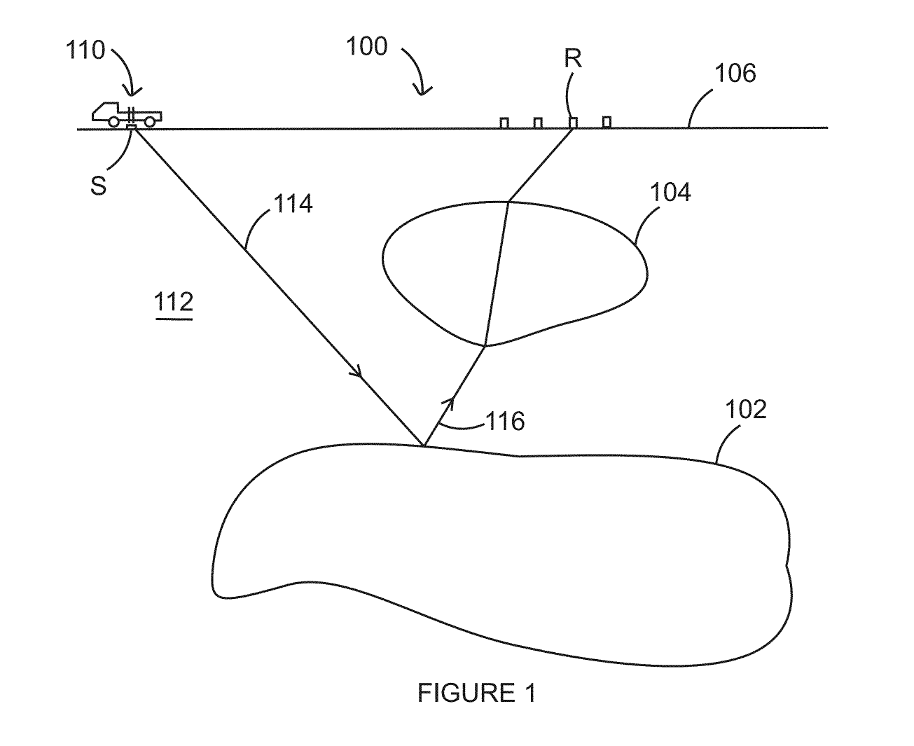

However, one issue with this approach is the common breakdown of ray tracing in and around the salt. In this regard, it is well known that the single path assumption inherent in most ray tracing methods results in an inaccurate representation of the complex multi-path nature of the actual wave propagation typical in regions of salt, as previously discussed above with regard to FIG. 1. Moreover, ray tracing algorithms generally require a certain level of smoothness of the velocity model for stability reasons, even in areas with strong contrasts, which also perturbs the ray kinematics. As such ray tracing in the presence of a salt dome can give rise to incomplete, noisy or even inaccurate images.

To overcome these problems, according to an embodiment, the inventors propose to use reverse-time migration (RTM) wavefield imaging of vertical seismic profile (VSP) transmitted energy to image the salt flank (or base) location. This is different from the traditional ray traced approach because the wavefield is now accurately computed within and around the salt bodies due to wave equation modelling.

In one embodiment, 3D RTM wavefield imaging of VSP transmitted energy is used to image the salt flank location, rather than the traditional ray tracing methods (other wave equation algorithms, such as one-way, could also be used).

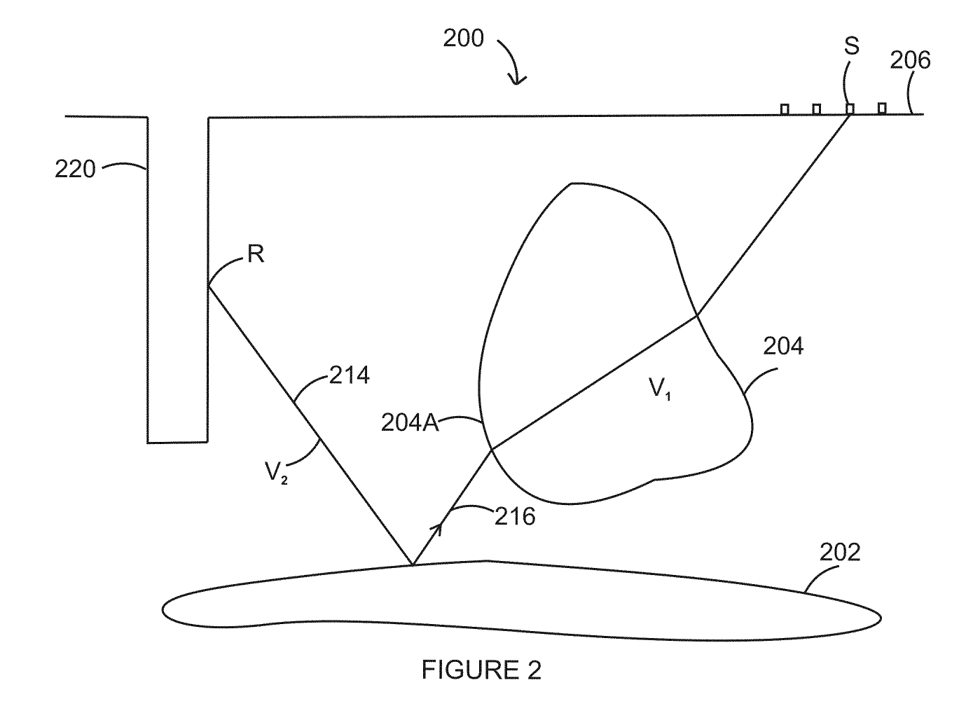

FIG. 2 shows a land seismic survey system 200 that uses one or more wells 220 for acquiring the seismic data. FIG. 2 shows the seismic receivers R being located inside the well 220. However, it is possible that the seismic receivers R are located on the earth's surface 206 and the sources S are located in the well. For this situation, the true Earth model contains a salt body, or salt dome, set into a sediment part. A first velocity model v1 can be constructed that contains the sediment part together with the salt dome (or more-likely a salt flooded version of the salt dome if the depth extent of the salt body is not known, wherein the salt velocity starts at the known top salt boundary and is continued straight down in depth to the bottom of the model), and a second velocity model v2 that contains the sediment part only, with the salt velocities replaced with sedimentary values.

The generic RTM imaging process (see, for example, “The Reverse Time Migration (RTM) algorithm,” Zhou, H. et al., 2010, Practical VTI RTM in Proceedings of 72nd EAGE Conference) includes three main steps: (a) forward propagation in time of a wavelet from the source location through a velocity model to generate a forward wavefield, (b) backward propagation in time (hence the name, “reverse time”) of the recorded seismic data at the receiver locations through the same velocity model to give a backward wavefield, and (c) the application of an imaging condition to the forward and backward wavefields at each time and subsequent combination to form an image of the subsurface.

Different from this traditional RTM method that uses the same velocity model for both the forward and backward wavefields, the new method uses the basic template of Li et al. (2003), with the difference that the two RTM wavefields (forward and backward) are propagated through different velocity models, namely salt flood v1 and sediment models v2, respectively. In one application, it is possible to invoke reciprocity in the RTM imaging process, such that the VSP receiver locations are treated as source locations, and the source locations are treated as receiver locations. This can be advantageous from a computational cost point of view. The following detailed description below assumes this reciprocity has been applied between the sources and the seismic receivers.

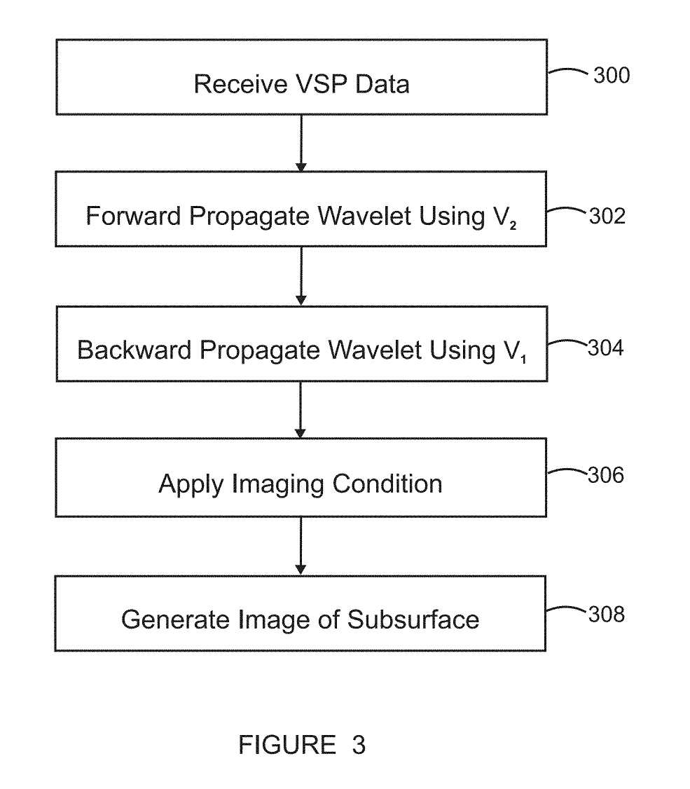

According to an embodiment illustrated in FIG. 3, the method receives in step 300 the VSP data. In step 302, a spike, or equivalent, wavelet at zero time is forward propagated in time, from the (downhole) source locations S (the locations of S and R in FIG. 2 having been swapped due to reciprocity having been applied) to a given point in the subsurface, using the sediment-only velocity model v2. In step 304, a spike, or equivalent, wavelet is back-propagated in time, from the (surface) receiver locations R through the salt-flood velocity model v1, where the timing of the injected wavelet corresponds to the first arrival travel-times coming from first arrival picking on the corresponding recorded VSP data.

To propagate the wavefield, a wave equation may be used. While many wave equations may be used, in the following an example of a wave equation discussed in Duveneck et al., 2008 or Zhang et al. 2011 is presented:

$$\frac{1}{{v}_{0}^{2}} {\partial }_{tt} {p}_{h} - ρ ( 1 + 2 ɛ ) {∇}_{h} ( \frac{1}{ρ} {∇}_{h} {p}_{h} ) - ρ \sqrt{1 + 2 δ } {\partial }_{z} ( \frac{1}{ρ} {\partial }_{z} {t}_{n} ) = s \\ \frac{1}{{v}_{0}^{2}} {\partial }_{tt} {t}_{n} - ρ \sqrt{1 + 2 δ} {∇}_{H} ( \frac{1}{ρ} {∇}_{h} {p}_{h} ) - ρ {\partial }_{z} ( \frac{1}{ρ} {\partial }_{z} {t}_{n} ) = {s}^{′} , \qquad ( 1 )$$

where ∇ₕ=(∂ₓ, ∂_{y}), pₕ is the horizontal stress, tₙ is the vertical stress, ρ is the density, v₀ is the P-wave (vertical) velocity, s and s′ are the source terms, ε and δ are the anisotropy parameters, and the ₜₜ subscript indicates the double time derivative. This equation can be extended to tilted transverse isotropy, orthorhombic anisotropy, etc.

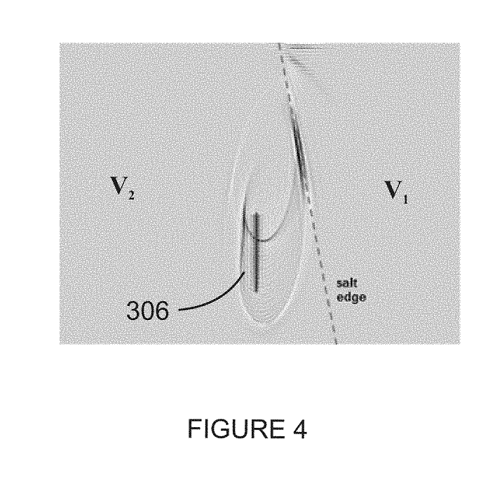

In step 306, an imaging condition is applied to these wavefields to form a coherent image at the lower salt boundary. The imaging condition may be, for example, a cross-correlation imaging condition. The cross-correlation imaging condition can be written as a zero-lag cross-correlation of the forward propagating wavefield, F, and the backward propagating wavefield, B, as follows:

$$I ( x ) = {\int }_{0}^{{t}_{ma x}} F ( x , t ) B ( x , t ) dt , \qquad ( 2 )$$

where I is the reflectivity (image) estimate, x is the spatial coordinate, tₘₐₓ is the maximum propagation time and t is the time axis. An exemplification of the output from the imaging condition (2) is shown in FIG. 4, where the salt velocity model v1 has a velocity of 4,500 m/s throughout the whole of the model and the sediment velocity model v2 has a velocity of 3000 m/s throughout the whole of the model. Note that these velocity models are overly simplified to illustrate the application of this method. Those skilled in the art would understand that other imaging conditions may be used and also that practical velocity models include many velocities. Based on the imaging condition I, an image of the surveyed subsurface may be generated in step 308. The above steps are then repeated for every source and the results may be combined.

In addition to using two different velocity models for the steps of the method discussed above, to reduce imaging artefacts unrelated to the salt imaging process, in one embodiment, it is possible to introduce a strong directivity into the source radiation, focussed in the direction of the salt edges 204A (see FIG. 2), when generating the source-side, forward propagating, wavefield.

Directivity in this context can be thought of as having a preferential dip/azimuth direction in the propagating energy generated by the source. Such directivity can be generated by, for example, using a source wavefield filtering approach, or through the use of plural sources with directional radiation patterns such as dipoles, quadrupoles, etc., or through other forms of source arrays with directivity characteristics (see also, U.S. Patent Application Publications nos. 2016/0202379 and 2017/0075011, assigned to the assignee of this application).

The directivity direction can come from the acquisition geometry and/or information from the VSP data either deterministically (for example, from picking) or following a scanning approach that extracts or combines the best salt edge image from a number of different directions. A similar directivity concept can also be applied to the receiver-side, backward propagating, wavefield.

In one embodiment, in relation to reducing the imaging artefacts, it is possible to also consider the imaging condition mentioned in step 306. Such an imaging condition usually takes the form of a zero-lag cross-correlation or deconvolution between the forward (source-side) and backward travelling (receiver-side) wavefields. Specifically, this imaging condition involves a summation-type process from zero to the maximum time of propagation (tₚᵣₒₚ_{_}ₘₐₓ). To reduce artefacts unrelated to the desired salt flank image, it may be advantageous to only use a selection of the times to contribute to the imaging condition. For example, instead of summing from 0 to tₚᵣₒₚ_{_}ₘₐₓ, in one application, equation (2) is summed from tₘᵢₙ to tₘₐₓ, where 0 tₘᵢₙ≤tₘₐₓ≤tₚᵣₒₚ_{_}ₘₐₓ, and the selection of [tₘᵢₙ, tₘₐₓ] could depend on the maximum energy in the cross-correlation or deconvolution.

In another embodiment, existing azimuthal imaging methods such as vector offset imaging (Xu et al., 2011) may also be used to help mitigate against the aforementioned artefacts. Finally, additional techniques to attenuate the back-scattered or other noise in RTM can be used, for example, the Laplacian filtering process (Zhang and Sun, 2009).

In addition to the previously mentioned references (Li et al., 2003; Li and Hewlett, 2014), McMechan et al. (1988) describe a hybrid approach combining wave propagation and ray tracing, whereas Roberts et al. (2009) promote the use of the one-way wave equation, both following the basic template of Li et al. (2003).

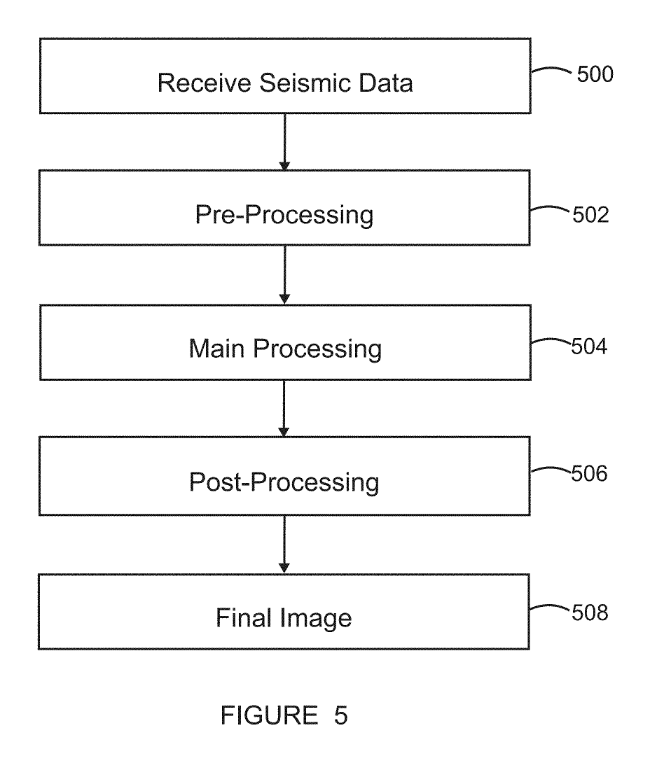

One skilled in the art, based on the teachings noted above, would be able to modify the method illustrated in FIG. 3 to apply, for example, any form of pre-processing to the data or image either prior to, directly in, or after the proposed method. For example, as illustrated in FIG. 5, one way of processing the seismic data includes a step 500 of receiving the VSP data at a processing device, which will be discussed later. In step 502 pre-processing methods are applied, e.g., demultiple, signature deconvolution, trace summing, vibroseis correlation, resampling, etc. In step 504 the main processing takes place, e.g., deconvolution, amplitude analysis, statics determination, common middle point gathering, velocity analysis, normal move-out correction, muting, trace equalization, stacking, noise rejection, amplitude equalization, etc. In step 506, final or post-processing methods are applied, e.g. migration, wavelet processing, inversion, etc. In step 508 the final image of the subsurface is generated.

Returning to FIG. 3, it is possible to perform the analysis on only a subset of the data: for example, by preferential selection of the recorded data that is directly above the salt body (or bodies), or by using a different component (x, y, z, or any combination of them) of the recorded VSP data. In one application, it is possible to perform the analysis in 2D, rather than 3D. In still another application, it is possible to perform a similar analysis on S-wave data, or converted wave data.

Other variations of the method presented in FIG. 3 include:

using different forms of, and/or ways of solving, the wave equation: for example, including anisotropy and/or attenuation and/or elastic effects;

changing the imaging condition used: for example, cross-correlation, deconvolution; with/without Laplacian filtering, wavefield separation/filtering, impedance/velocity kernels, scattering angle filtering, etc.;

using a different migration algorithm to RTM: for example, Beam, one-way wave equation or Kirchhoff algorithms;

using additional parts of the wavefield, other than the direct transmitted arrivals, to drive the process: for example, a reflection (or multiple) of the transmitted arrivals;

invoking reciprocity to swap source and receiver locations;

injecting the recorded data, potentially muted, instead of a wavelet at the picked arrival travel-times;

using a different wavelet to a spike: for example, Ricker, Orsmby, etc.;

using a hybrid scheme, where, for example, a ray tracing technique is used in one part of the model and a wave equation solution in another;

using a “triangulation” approach as opposed to the “reverse time” approach described here. In the “triangulation” approach, the source and receiver wavefields are both extrapolated forward in time and the image is formed when the sum of the individual legs is equal to the total travel-time from source to receiver (as measured from the first arrival travel-time picks on the recorded VSP data). This approach would not require the filtering of the low-frequency artefacts in RTM (for example, by Laplacian filtering); and

using another method, potentially not from seismic data, to get the first arrival travel-times used in the process.

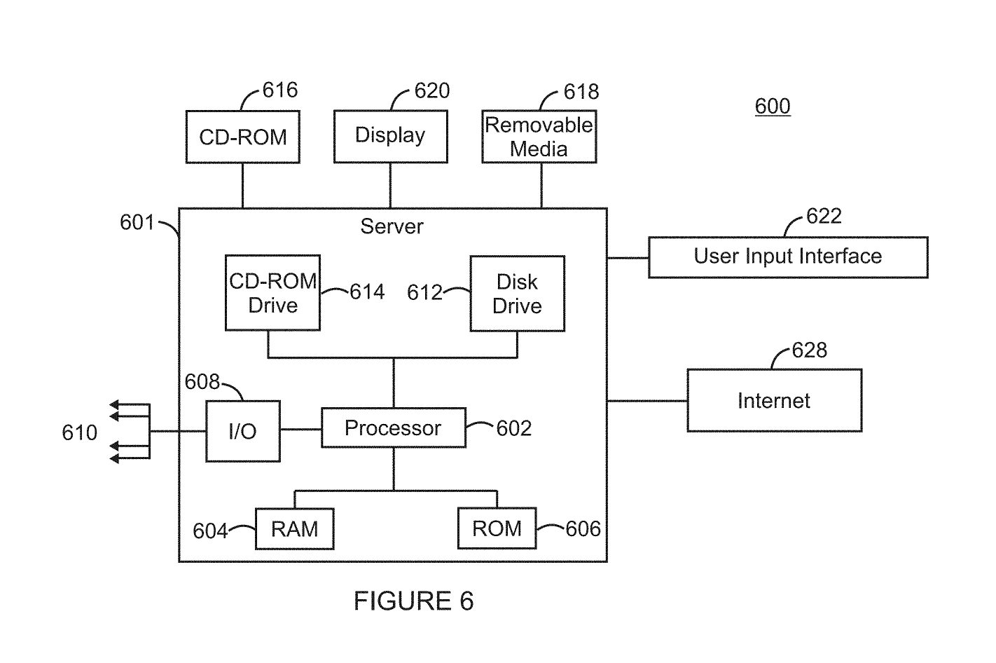

The above-described methods may be performed using the apparatus illustrated in FIG. 6. Hardware, firmware, software or a combination thereof may be used to perform the various steps and operations. Apparatus 600 may include server 601 having a central processor unit (CPU) 602 coupled to a random access memory (RAM) 604 and to a read-only memory (ROM) 606. ROM 606 may also be other types of program storage media, such as programmable ROM (PROM), erasable PROM (EPROM), etc. Methods for obtaining an image of an explored subsurface formation may be implemented as computer programs (i.e., executable codes) non-transitorily stored on RAM 604 or ROM 606.

Processor 602 may communicate with other internal and external components through input/output (I/O) circuitry 608 and bussing 610, which are configured to obtain detected data related to waves traveling through an explored subsurface formation. Processor 602 carries out a variety of seismic data processing functions, as dictated by software and/or firmware instructions, and may include plural processing elements cooperating to perform the data processing functions.

Processor 602 is configured to generate modeled data corresponding to the detected data using two velocity models of the formation, to apply an imaging condition, and to generate an image of geophysical features inside the explored subsurface formation based on forward and backward calculated wavefields.

Server 601 may also include one or more data storage devices, including disk drive 612, CD-ROM drive 614, and other hardware capable of reading and/or storing information, such as a DVD, etc. In one embodiment, software for carrying out the above-discussed steps may be stored and distributed on a CD-ROM 616, removable media 618 or other form of media capable of storing information. The storage media may be inserted into, and read by, devices such as the CD-ROM drive 614, disk drive 612, etc. Server 601 may be coupled to a display 620, which may be any type of known display or presentation screen, such as LCD, plasma display, cathode ray tube (CRT), etc. Server 601 may control display 620 to exhibit various images generated during data processing.

User input interface 622 includes one or more user interface mechanisms such as a mouse, keyboard, microphone, touchpad, touch screen, voice-recognition system, etc. Server 601 may be coupled to other computing devices, such as the equipment of a vessel, via a network. The server may be part of a larger network configuration as in a global area network (GAN) such as the Internet 628, which allows ultimate connection to various landline and/or mobile devices.

The disclosed embodiments provide a method and device for calculating an image of the subsurface in the presence of a salt. The method uses two different velocity models, one of the salt and one for the sediment. VSP data is used as input for this method. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

Li, Y., Faw, D., Jackson, J., Dushman, D. and Doherty, F., 2003, Multifarious VSP methods for imaging of complex structures with three component data: First Break, 21, 43-48.
Li, Y. and Hewlett, B., 2014, Reflection Salt Proximity: 76th EAGE Conference & Exhibition, Tu G102 12.
McMechan, G. A., Hu, L. and Stauber, D., 1988, Determination of salt proximity by wave-field imaging of transmitted energy: Geophysics, 53, 1109-1112.
Roberts, M. A., Hornby, B. E. and Rollins, F., 2009, 3D salt flank imaging with transmitted arrival VSP data: SEG Houston, 4129-4133.
Xu, Q., Li, Y., Yu X. and Huang, Y., 2011, Reverse Time Migration Using Vector Offset Output to Improve Subsalt Imaging—A Case Study at the Walker Ridge GOM: 73th EAGE Conference & Exhibition, G023.
Zhang, Y. and Sun, J., 2009, Practical issues of reverse time migration: true-amplitude gathers, noise removal and harmonic-source encoding: First Break, 26, 29-35.

What is claimed is:

1. A method for obtaining an image of an explored subsurface formation, the method comprising:
receiving seismic data, wherein the seismic data is associated with a source or a seismic sensor placed in a well;
forward propagating a first wavelet from the source using a first velocity model;
backward propagating a second wavelet from the seismic sensor using a second velocity model, which is different from the first velocity model; and
applying an imaging condition to the forward propagated first wavelet and the backward propagated second wavelet to calculate a reflectivity of the subsurface.

2. The method of claim 1, wherein the first or second velocity model is a sedimentary velocity model.

3. The method of claim 1, wherein the first or second velocity model is a salt velocity model.

4. The method of claim 1, wherein the well is drilled next to a salt.

5. The method of claim 1, wherein the reflectivity is calculated for a subsurface located under a salt.
